(19) United States
(12) Patent Application Publication
(10) Pub. No.: US 2020/0380881 A1
(43) Pub. Date: Dec. 3, 2020

(54) METHOD FOR ACHIEVING GOALS THROUGH EMPHASIS ON PERSISTENCE

(71) Applicant: Suzanne Labombarda, Hoboken, NJ (US)

(72) Inventor: Suzanne Labombarda, Hoboken, NJ (US)

(21) Appl. No.: 16/428,977

(22) Filed: Jun. 1, 2019

(51) Int. Cl. G09B 19/00; G09B 7/02

(52) U.S. Cl. CPC G09B 19/00; G09B 7/02

(57) ABSTRACT

A method for enhancing a student's likelihood of achieving success emphasizing the core tenets of rewarding failure when failure is achieved using maximal effort and persistence as the best guarantee of successful goal achievement.

### FIELD OF THE INVENTION

The present invention relates generally to teaching methods, and specifically on teaching methods that emphasize effort over outcome.

### BACKGROUND

Today's children are faced with increasing challenges unlike those common in any other time in history. Illegal drug use often begins in the teen years (Ali, S., Mouton, C. P, Jabeen, S., Ofoemezie, E. K., Bailey, R. K., Shahid, M., and Zeng, Q. 2011. Early Detection of Illicit Drug Use in Teenagers, Innov Clin NeuroSci December; 8(12):24-28). One in five children in the 8^{th} grade report drinking alcohol (Johnston, L. D.; O'Malley, P. M.; and Bachman, J. G. Monitoring the Future: National Results on Adolescent Drug Use. Overview of Key Findings, 2002. NIH Pub. No. 03-5374. Bethesda, Md.: National Institute on Drug Abuse (NIDA), 2003). Almost half of children in grades 4 through 12 report being bullied (Facts About Bullying, https://www.stopbullying.gov/media/facts/index.html, accessed on Apr. 27, 2018). More teenagers die from suicide than from cancer, heart disease, AIDS, birth defects, stroke, pneumonia, influenza, and chronic lung disease combined (The Facts About Teen Suicide, https://americanspcc.org/facts-teen-suicide, accessed on Apr. 27, 2018). It is clear now more than ever that today's children need additional guidance and direction to successfully navigate the waters of the child and teenage years.

Schools are a place of structure and academic support providing rigorous instruction in math, art, science and the like. Curriculums are well tested, standardized, and designed to position students for success, typically defined as graduation of high school, obtaining a college degree, and perhaps the ability to enter one's career of choice in early adulthood. Current statistics indicate, however, that almost one in five children do not graduate high school, much less attend college. Of those who attend college, 30% drop out within their first year (Dropouts Loom Large for Schools |Higher Education|US News https://www.usnews.com/education/articles/2009/08/ . . . /dropouts-loom-large-for-schools. accessed on Apr. 27, 2018). Despite the implementation of rigorous and advanced academic programs in schools, it is clear that youths simply are not being provided with the full range of skills they need to succeed.

The self-help industry has ballooned into a 10 billion dollar industry (The Self-Help Industry Helps Itself to Billions of Dollars. http://brainblogger.com/2014/05/23/the-self-help-industry-helps-itself-to-billions-of-dollars, accessed on Apr. 27, 2018). Dissatisfied with the status of their lives, millions seek help on everything from how to make more money to how to lose weight. Despite this multi-billion dollar industry, most people are simply not able to achieve their goals. Reaching any goal, whether it be graduating high school, obtaining a college degree, or even losing weight, requires individuals to persevere past the inevitable ups and downs that are part of reaching any long-term goal. The road to successful weight loss, for example, is filled with many incremental changes in weight (i.e. −5 lbs, +3 lbs, −4 lbs, etc.) that over several months, result in weight loss upon the condition that there are a greater number of incidences of weight losses verses weight gains. In fact, achieving long-term success of any goal requires the ability to continue, even after failing time and time again, sometimes hundreds or even thousands of times.

It is no secret that failure is viewed in our society as being shameful. It is generally not openly discussed with and often actively hidden from others. Failure elicits feelings of disappointment, anger, frustration, sadness, regret, and confusion. Once an individual experiences failure and the associated negative feelings, a common reaction is to simply stop trying, as a natural protection against that which causes emotional distress. In the individual trying to lose weight, going to a party and overindulging may cause such unpleasant feelings that many dieters simply give up, rather than risk a repeat of the unpleasant feelings associated with breaking their diet. For the student who studies for a test but still receives a low grade, she may give up studying all together.

In our society, success means getting an A, being offered the job, getting into a desired college, making the sports team, or winning the game. As such, achievement of any of these goals is celebrated, rewarded, and commended. Failure is not only not celebrated, rewarded, or commended, but often punished, chastised, or treated otherwise negatively. This outside reinforcement is compounded upon the individual's own feelings regarding the failure.

In the pursuit of any goal or mastery of a skill, an attempt is made that is either successful, or unsuccessful. If unsuccessful, the individual feels the accompanying feelings of failure (disappointment, anger, frustration), and through classic operant conditioning over many attempts, the individual eventually stops trying to avoid these negative feelings. In short, people simply give up. Childhood is a time when core beliefs, actions and behaviors are being shaped and reinforced. Childhood therefore provides a ripe opportunity for a paradigm shift, as research has shown that children enrolled in a behavior change program maintain healthy behaviors up to ten years later, whereas their adult counterparts do not (Epstein, L. H., Valoski, A. M, Kalarchian, M A & McCurley, J. Do children lose and maintain weight easier than adults? Obesity Research).

The state of the art recognizes that persistence or “grit” is a better predictor of success than talent. This is discussed, for example, in Angela Lee Duckworth's April 2013 TED talk. Even Ms. Duckworth, however, admits that she, and the then-current science, do not know how to engender grit and a solid work ethic. The present invention seeks to address that issue.

Therefore there is a need for a method of enhancing a student's likelihood to succeed that embraces and celebrates failure as a necessary step on the path to successfully attaining any long-term goal.

### SUMMARY OF THE INVENTION

The present invention is a method for enhancing a student's likelihood of achieving success. The method of the present invention may be performed in a formal educational setting or a non-formal setting, such as within the home, or, optimally, a combination of the two. The method of the present invention is scalable and applicable to achieving success in all range and manner of goals. As noted above, as childhood may be the most opportune time to teach healthy behaviors, this method is geared toward children, but it is applicable to people of all ages. While the terms “students” and “children” will be used frequently herein, it is understood that the present invention is not relegated to the young.

The hallmark of the present invention is a celebration of failure as an expected and necessary aspect of achieving any goal. Given society's emphasis on successful results, this aspect is non-obvious, novel, and useful. The method also emphasizes that persistent maximal effort is more important than latent or innate talent in achieving a goal. Again, this core tenet teaches away from the common termination of progress toward a particular goal that is quitting in frustration or in the assumption that one is simply not capable of achieving the goal. Placing a greater emphasis on effort versus outcome provides the foundation for success, as research has shown that sustained effort is the key to achieving long-term goals. It is sustained effort that ultimately causes the achievement of a long-term goal after encountering the inevitable ups and downs along the way (Duckworth A. L., Peterson C., Matthews M. D., Kelly D. R. (2007). Grit:

perseverance and passion for long-term goals. J. Pers. Soc. Psychol. 92, 1087-1101 10.1037/0022-3514.92.6.1087).

In its most basic form the method of the present invention includes the steps of encouraging the student to set a goal; encouraging the student to formulate milestones toward achieving the goal; encouraging the student to attempt to progress through the milestones; encouraging the student to record her progress through the milestones; monitoring the student's progress through the milestones; determining whether the student is using maximal effort to proceed through the milestones; providing positive feedback to the student upon her success in proceeding through one or more milestones while using maximal effort; providing positive feedback to the student upon her failure to proceed through one or more milestones while using maximal effort; and emphasizing that struggle and failure are expected and necessary aspects of achieving the goal and that effort and persistence are the most important factors in achieving the goal. It is understood that milestones are steps toward achieving the goal. As the present invention is a method with steps, however, the term milestones is used so as to avoid confusion with the steps of the method.

In preferred embodiments of the method of the present invention, the step of providing positive feedback to the student upon her failure to proceed through one or more milestones while using maximal effort also includes the step of encouraging the student to formulate a strategy to succeed in proceeding through the failed one or more milestones upon reattempt. The step of providing positive feedback to the student upon her failure to proceed through one or more milestones while using maximal effort may also include the step of suggesting that the student edit the failed one or more milestones so as to make them more achievable upon reattempt. This editing step may entail suggesting that the student break the failed one or more milestones into smaller sub-milestones or suggesting that the student edit the failed one or more milestones to make them more realistic for the student's circumstances, for examples. The step of providing positive feedback to the student upon her failure to proceed through one or more milestones while using maximal effort may also include the step of encouraging the student to focus on improvement and discouraging the student from focusing on self-flagellation.

In preferred embodiments of the method of the present invention, the steps of encouraging the student to set a goal and encouraging the student to formulate milestones toward achieving the goal also includes the step of encouraging the student to add specificity to the goal and the milestones.

In preferred embodiments of the method of the present invention, the step of encouraging the student to set a goal includes asking the student questions to help the student identify an area on which the student would like to improve or something the student would like to achieve.

In preferred embodiments of the method of the present invention, the step of encouraging the student to record her progress through the milestones entails the step of encouraging the student to reflect on progress through the milestones regarding what actions are resulting in success and what actions might be done differently so as to better produce success and/or the step of encouraging the student to identify trends that correlate her behavior with progress or lack thereof through the milestones.

Preferred embodiments of the method of the present invention also include the step of encouraging the student to identify and take advantage of resources to aid the student through her progress through the milestones, which may include the step of encouraging the student to ask people for help through her progress through the milestones.

Preferred embodiments of the method of the present invention also include the steps of encouraging the student to celebrate her own success in proceeding through the milestones; encouraging the student to edit the milestones to make them more challenging upon succeeding in proceeding through one or more milestones with less than maximal effort; encouraging the student to engage with accountability partners to support her in her progress through the milestones; encouraging the student to modify her environment to facilitate achieving the milestones; and emphasizing the steps of the method through group and/or solo activities.

Preferred embodiments of the method of the present invention also include the step of training a teacher to perform the steps of the method. This step may entail providing the teacher with a workshop; providing the teacher with a teaching manual; and/or providing the teacher with access to an online portal that provides at least information regarding the steps of the method and resources pertaining to the steps of the method.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1A is a prior art general flow chart of a typical goal pursual.

FIG. 1B is a generalized flow chart indicating a core tenet of the present invention.

FIG. 2A is a flow chart indicating the steps of the method of the present invention in its most basic form.

FIGS. 2B and 2C are charts detailing steps of the method of the present invention.

FIG. 2D is a block diagram indicating steps included in preferred embodiments of method of the present invention.

FIG. 3 is a sample page of a teaching manual as used in the method of the present invention.

### DETAILED DESCRIPTION

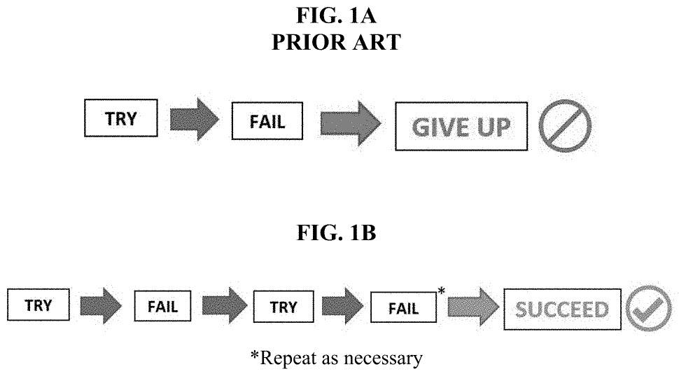

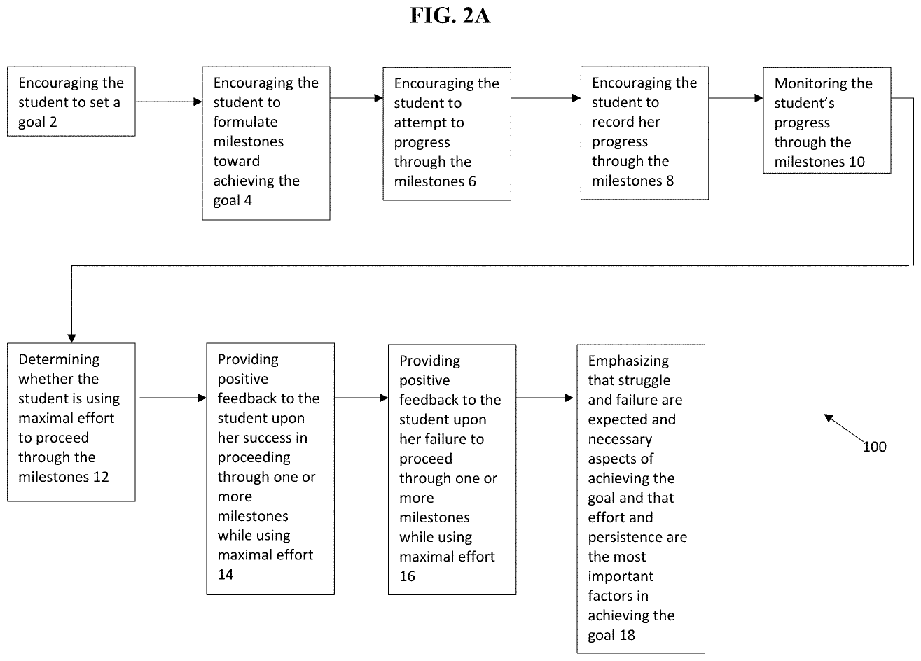

Referring first to FIGS. 1A and 1B a prior art general flow chart of a typical goal pursual and generalized flow chart indicating a core tenet of the present invention are provided, respectively. In prior art FIG. 1A, the standard leaning pathway is Try, Fail, Give Up. All too often, children and people of all ages will give up on pursuing a goal at the first failure or struggle along the path. Goals will never be attained in such a manner. In FIG. 1B, however, a more realistic approach is presented—Try, Fail, Try, Fail, Succeed. The approach of the present invention acknowledges and celebrates failure as a necessary and expected part of the process of reaching a goal, and champions the sustained effort put into reaching the goal rather than the reaching the goal itself. The program presented in the present invention celebrates failure, reinforces effort, and solidifies neural pathways to increase the likelihood that a child will persist when faced with an obstacle, setback, or challenge.

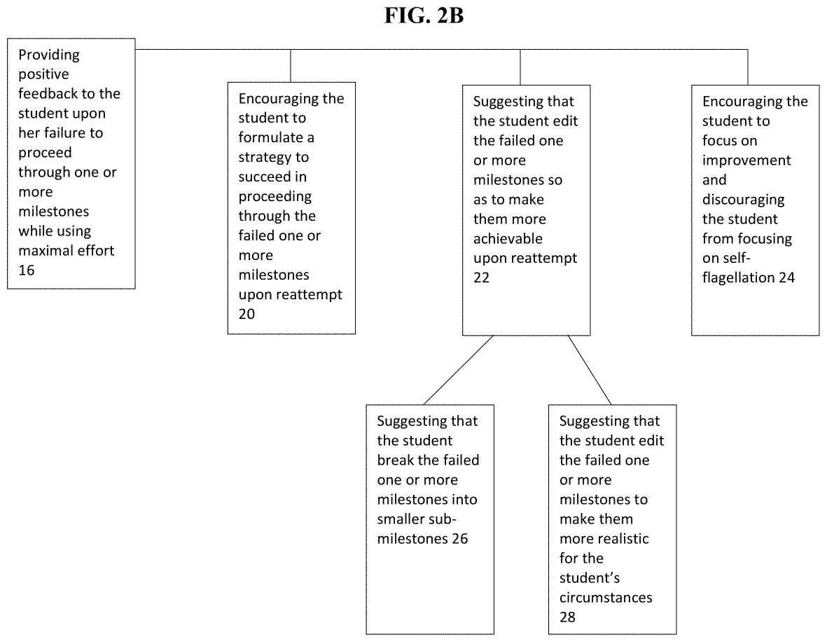

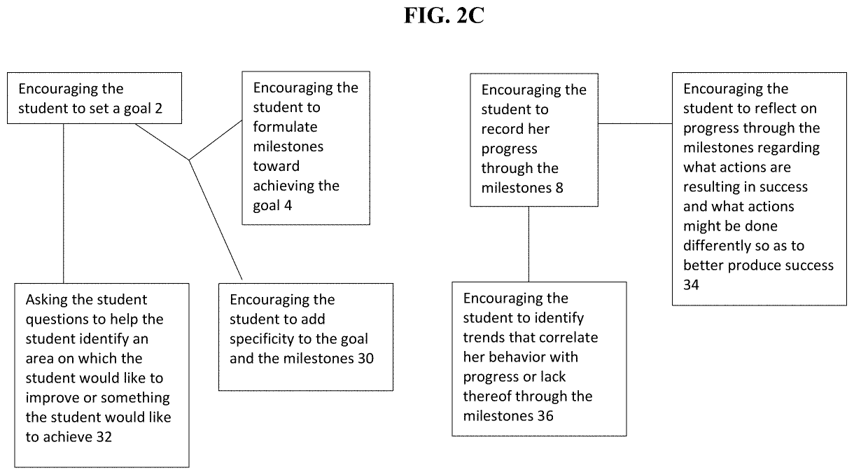

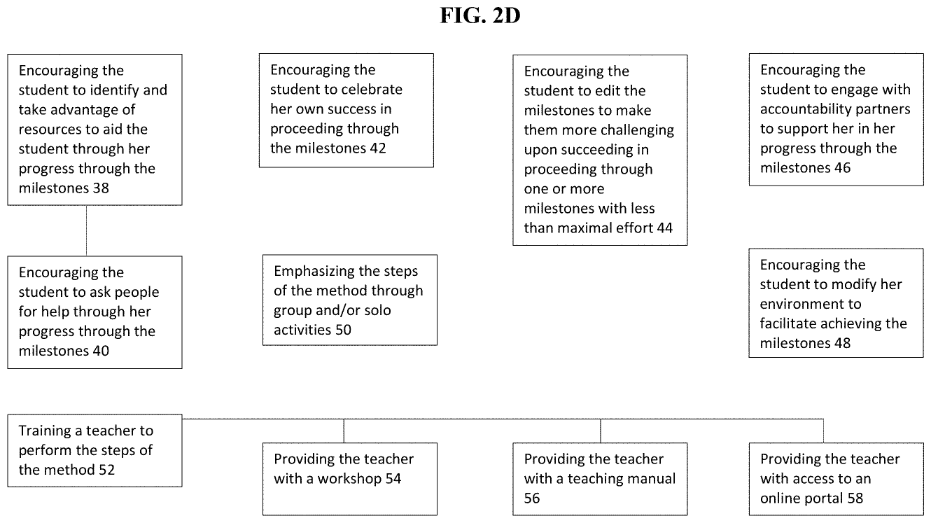

Now referring to FIG. 2A, the steps of method 100 of the present invention are provided. These steps include encouraging the student to set a goal 2; encouraging the student to formulate milestones toward achieving the goal 4; encouraging the student to attempt to progress through the milestones 6; encouraging the student to record her progress through the milestones 8; monitoring the student's progress through the milestones 10; determining whether the student is using maximal effort to proceed through the milestones 12; providing positive feedback to the student upon her success in proceeding through one or more milestones while using maximal effort 14; providing positive feedback to the student upon her failure to proceed through one or more milestones while using maximal effort 16; and emphasizing that struggle and failure are expected and necessary aspects of achieving the goal and that effort and persistence are the most important factors in achieving the goal 18. As each step is described in more detail below, it is understood that the examples given regarding each step are merely exemplary. One of ordinary skill in the art will recognize that these steps may be performed in many ways, and each of these is considered to be within the scope of the present invention.

The first step of method 100 is encouraging the student to set a goal 2. This step may begin with a group discussion over questions such as, what is a goal?; what are some examples of goals people set?; why is it important to set goals? Students may engage in a group activity, such as matching a list of goals with a list of actions appropriate for that goal. (This is an example of a step 50 group activity, discussed below with reference to FIG. 2D.) Finally, the student may self-reflect on what goals she wishes to achieve.

The second step of method 100 is encouraging the student to formulate milestones toward achieving the goal 4. The student is encouraged to think through actions that will bring her closer to her goal. The student may fill in a worksheet where she enters her goal, “I will” and adds actions, steps, or milestones toward that goal under “by.” For example, “I will get an A in math by joining a study group.” (This is an example of a step 50 solo activity, discussed below with reference to FIG. 2D.) The student's goal is to get an A in math. One of her milestones to achieve this goal is to join a study group.

The third step of method 100 is encouraging the student to attempt to progress through the milestones 6. This step 6 is ongoing. In fact, all of steps 8, 10, 12, 14, 16, and 18, discussed in more detail below are really aspects of this step 6.

The fourth step of method 100 is encouraging the student to record her progress through the milestones 8. During each lesson, the student is encouraged to self-reflect on her progress and go through a checklist of what behaviors she did or did not undertake during a time period. (This is an example of a step 50 solo activity, discussed below with reference to FIG. 2D.)

The fifth step of method 100 is monitoring the student's progress through the milestones 10. This may not be formal. There is some emphasis on the student being self-driven while proceeding through her milestones toward her goal. As such, an authoritarian approach to monitoring, while an option, may be discouraged. A teacher, parent, care-giver, i.e. the executor of the method, may be able to monitor progress simply through interaction with the student. The student may also share her recording of her progress. Although this step may be performed informally, the executor of method 100 needs to know when the student has succeeded or failed in progressing toward her goal so that the executor knows when to administer feedback.

The sixth step of method 100 is determining whether the student is using maximal effort to proceed through the milestones 12. This is a key step in method 100 because sustained effort in pursuing goals is a core tenet of the present invention. Whether the student succeeds or fails, if she is not really trying very hard, then she is not proceeding through the program as intended by the present invention. If she is really trying hard, however, whether she succeeds or fails, the behavior pattern of that effort will receive positive reinforcement, as discussed with the next two steps.

The seventh and eight steps of method 100 are providing positive feedback to the student upon her success in proceeding through one or more milestones while using maximal effort 14 and providing positive feedback to the student upon her failure to proceed through one or more milestones while using maximal effort 16. These steps 14, 16 may not necessarily occur in the order listed above. If the student is using maximal effort, but fails at achieving a milestone before she succeeds, then step 16 will occur before step 14. With the use of timely positive reinforcement, the present invention effectively provides a “road map” of how to achieve a goal, by providing a positive booster (i.e. praise) at precisely the point where giving up typically occurs. Through repeatedly reinforcing an alternate behavioral pattern, method 100 strengthens and solidifies neural pathways for effort and persistence, which ultimately provides a road map for long-term success. Studies have shown that children who have high levels of reinforcement for an item will work very hard in the attainment of that item. Improving the reinforcing value of effort, therefore, is likely to increase the frequency of the desired behavior (i.e. sustained effort over time).

The ninth step in method 100 is emphasizing that struggle and failure are expected and necessary aspects of achieving the goal and that effort and persistence are the most important factors in achieving the goal 18. This step 18 is a key aspect of the present invention. It is achieved throughout the execution of method 100 (not necessarily at the end as may be suggested by a list of steps of method 100) and may be achieved in a variety of ways. The method executor may repeatedly use a mantra or catch phrase, for example. It could be as simple as “never quit.” The use of key language phrases reinforces the principles of the present invention. Another way to implement step 18 may be when discussing how to perform step 8 of recording progress: The executor may emphasize that any progress is a success, even if the goal is not met—simply trying and taking action is making progress in the right direction. Groups of students may brainstorm a list of people they admire and then research what struggles those people have overcome to get to their position worthy of admiration. (This is an example of a step 50 group activity, discussed below with reference to FIG. 2D.) The executor may begin a group discussion about obstacles and why they are helpful and necessary. Groups of students may then create an obstacle course to reinforce the ideas discussed. (This is another example of a step 50 group activity, discussed below with reference to FIG. 2D.) The executor may emphasize the importance of practicing to become good at something and give examples of popular celebrities that have had to practice their craft to get to their position, emphasizing that very few people achieve goals based on innate talent alone. The student may fill out a worksheet asking what skill she wants to improve and how many hours she thinks she could dedicate toward that improvement. (This is an example of a step 50 solo activity, discussed below with reference to FIG. 2D.) One of ordinary skill in the art will recognize that step 18 may be achieved in many different ways and that the above recitations are merely examples. It is worth noting that step 18 is significantly more effective when combined with group and solo activities, as discussed below with respect to step 50.

Now referring to FIG. 2B, the key step 16 of the present invention is described in detail. Step 16 of providing positive feedback to the student upon her failure to proceed through one or more milestones while using maximal effort 16 may also include the step of encouraging the student to formulate a strategy to succeed in proceeding through the failed one or more milestones upon reattempt 20; suggesting that the student edit the failed one or more milestones so as to make them more achievable upon reattempt 22; and/or encouraging the student to focus on improvement and discouraging the student from focusing on self-flagellation 24. The step of suggesting that the student edit the failed one or more milestones so as to make them more achievable upon reattempt 22 may entail suggesting that the student break the failed one or more milestones into smaller sub-milestones 26 and/or suggesting that the student edit the failed one or more milestones to make them more realistic for the student's circumstances 28, for examples.

The step of encouraging the student to formulate a strategy to succeed in proceeding through the failed one or more milestones upon reattempt 20 is an important step in emphasizing that failing to achieve a milestone is merely a setback that may be overcome, rather than an indication of failure in achieving the ultimate goal. Step 20, in fact, is arguably a part of key step 18 as much as key step 16. Step 20 encourages the student to look back at the failure objectively and with a plan to change course on further attempts.

The step of suggesting that the student edit the failed one or more milestones so as to make them more achievable upon reattempt 22 is a recognition that the student may have been initially too ambitious or unrealistic in planning her milestones. Again, this step encourages objective thinking about how to change course to achieve the ultimate goal, rather than quitting because the milestone was too difficult. This step 22 may entail, for example, suggesting that the student break the failed one or more milestones into smaller sub-milestones 26. Let's say the student has a milestone of running an 8 minute mile toward her ultimate goal of joining the cross country team, but she has not been able to get to that speed and is getting overly fatigued in trying. With step 26, she would be encouraged to form a training plan with sub-milestones less rigorous than the 8 minute mile that will get her to a point where she can meet the 8 minute mile milestone. Step 22 may also entail suggesting that the student edit the failed one or more milestones to make them more realistic for the student's circumstances 28. Let's say the student set a milestone of studying an extra hour every evening toward her goal of getting an A in math. Perhaps she has failed in this milestone because she can only fit in an extra 30 minutes every evening during the week. With step 28, she might edit her milestone to be studying 1.5 hours on each weekend day; studying for half an hour during lunch 3 times a week; and continuing to study an extra 30 minutes each evening. With her schedule, the edited milestone that takes into the account the realities of her schedule, she has created an achievable new milestone that will be equally as effective as the original unachievable milestone.

Encouraging the student to focus on improvement and discouraging the student from focusing on self-flagellation 24 is another important step. It is easy for the student to beat themselves up over not having achieved a milestone toward a goal. The energy put toward this self-criticism is much more productively focused on ways to improve.

Now referring to FIG. 2C, additional steps of method 100 of the present invention are details. The steps of encouraging the student to set a goal 2 and encouraging the student to formulate milestones toward achieving the goal 4 may also include the step of encouraging the student to add specificity to the goal and the milestones 30. The step of encouraging the student to set a goal 2 may also include asking the student questions to help the student identify an area on which the student would like to improve or something the student would like to achieve 32. The step of encouraging the student to record her progress through the milestones 8 may also entail the step of encouraging the student to reflect on progress through the milestones regarding what actions are resulting in success and what actions might be done differently so as to better produce success 34 and/or the step of encouraging the student to identify trends that correlate her behavior with progress or lack thereof through the milestones 36.

The step of encouraging the student to add specificity to the goal and the milestones 30 will likely make the student's goals and milestones more achievable. This step 30 may be performed by engaging in a group discussion about why specificity will help students reach their goals. While the student reflects on how she might make her goals and/or milestones more specific, the executor might suggest general areas that might be more specific or suggest that the student think about times, locations, and/or resources that could be added to the goals and/or milestones more specific.

The step of asking the student questions to help the student identify an area on which the student would like to improve or something the student would like to achieve 32 is usually executed when the student is having difficulty identifying goals. Ultimately it will still be the student that comes up with her own goals. Asking questions regarding what she would like to improve might frame the issue differently so that she may evade her mental block.

The steps encouraging the student to reflect on progress through the milestones regarding what actions are resulting in success and what actions might be done differently so as to better produce success 34 and encouraging the student to identify trends that correlate her behavior with progress or lack thereof through the milestones 36 are closely related. Both involve self-reflection and are a natural counterpart to recording the student's progress. (These steps 34, 36 are also an example of a solo activity, discussed below with reference to FIG. 2D.)

Now referring to FIG. 2D, additional steps of the method 100 of the present invention, beyond those of the basic method provided in FIG. 2A are provided. Method 100 may also include the steps of encouraging the student to identify and take advantage of resources to aid the student through her progress through the milestones 38, which may include the step of encouraging the student to ask people for help through her progress through the milestones 40; encouraging the student to celebrate her own success in proceeding through the milestones 42; encouraging the student to edit the milestones to make them more challenging upon succeeding in proceeding through one or more milestones with less than maximal effort 44; encouraging the student to engage with accountability partners to support her in her progress through the milestones 46; encouraging the student to modify her environment to facilitate achieving the milestones 48; emphasizing the steps of the method through group and/or solo activities 50; and training a teacher to perform the steps of the method 52, which may entail providing the teacher with a workshop 54; providing the teacher with a teaching manual 56; and/or providing the teacher with access to an online portal that provides at least information regarding the steps of the method and resources pertaining to the steps of the method 58.

The step of encouraging the student to identify and take advantage of resources to aid the student through her progress through the milestones 38 is a counterpart to step 30 of making goals and milestones more specific. Students may be myopic in considering how to achieve their milestones and goals. Encouraging them to widen their field of vision to the resources available to them will help them make their milestones and goals more specific and achievable. Step 38 often includes the step of encouraging the student to ask people for help through her progress through the milestones 40. The student may not necessarily think of people, such as her parents, as resources. The student may also have fears about asking for help. This step may be achieved through a group discussion about the issues surrounding asking for help. The executor may lead a group activity such as having the students imagine they are shipwrecked on an island and have each student say one thing she has with her that is important to her. A discussion may then ensue regarding how that item and that person can aid the group in their shipwrecked situation. (These are examples of a step 50 group activity, discussed below.)

The step of encouraging the student to celebrate her own success in proceeding through the milestones 42 is a nod to reality in that there may not always be other people around to celebrate one's victories. This step emphasizes that internal motivation is valid and essential.

The step of encouraging the student to edit the milestones to make them more challenging upon succeeding in proceeding through one or more milestones with less than maximal effort 44 is part of the core tenet of the present invention of persistent effort to achieve goals. If the student sets goals that are too easy, so that she need not exert maximal effort in order to achieve them, then she will be ill-prepared later in life for inevitably more challenging goals. This step 44 is somewhat controversial because it flies in the face of our outcome-based societal norms. Society would say that she set a goal and achieved it and that is laudable. Perhaps so, but the purpose of the present invention is to encourage persistence in attaining goals. If the goals the student is setting do not require persistence and struggle, then the student will not benefit from the present invention.

The step of encouraging the student to engage with accountability partners to support her in her progress through the milestones 46 is another step that will help her meet her milestones. An accountability partner is a second party that the student has given some sort of role in the student's milestone or goal, i.e. some outside party to whom the student feels some form of accountability. For the student who wants to run an 8 minute mile, one of her milestones might be getting up and doing sprints before school twice a week. Her accountability partner might be someone who will sprint with her or time her or just walk to and from the track with her.

Regardless of the accountability partner's role, the student is much more likely to stick to that milestone if there is someone else meeting her on those early mornings. For the student that wants an A in math and has joined a study group as a milestone toward that goal, she may make the entire study group her accountability team. She may pledge that she will show them her test grades, thus making her accountable to them on some level.

The step of encouraging the student to modify her environment to facilitate achieving the milestones 48 capitalizes upon the idea of stimulus control. The student may change her surroundings to make achieving her milestones and goals easier or otherwise more likely. The student who has a milestone of getting up and doing sprints before school twice a week might lay out everything she needs for the outing the night before, including her running outfit, running shoes, water bottle, and headlamp. When she is tired the next morning, she cannot give herself the excuse of not having everything ready to go as a reason for not meeting her milestone. In a subtle way, therefore, she has made achieving that milestone easier for herself. Another example of stimulus control might be encouraging the student to include her goals on a postcard. She may decorate the postcard so that it is aesthetically appealing; laminate it for permanence; and keep it on display for her to see every day. Not only is making the postcard an example of a solo or group activity, as discussed below with respect to step 50, but having the postcard as a constant, pleasant, but passive, reminder to herself of the importance of her goals will keep her persisting toward those goals. One of ordinary skill in the art will recognize that there are many ways in which a student may manipulate her environment to facilitate achieving her goals and milestones. Encouraging the student to partake in each of such manipulations is considered within the scope of the present invention.

Throughout this description, the step of emphasizing the steps of the method through group and/or solo activities 50 has been referenced. Every aspect of the present invention is reinforced through step 50. This reinforcement entails group and/or solo activities including but not limited to interactive storytelling, role play, specialized praise, modeling, drawing, writing, and peer influence. Interactive story telling exercises reinforce the program principles through modeling. A series of role play exercises reinforce the program principles through direct practice. Delivery of praise in alignment with the program, especially for failure at the key moment when a student might quit, is an important aspect of the present invention. Praise may also be encouraged from the students' peers. It is well established that children's behaviors may be influenced by various methods of learning, including both indirect and direct methods. Modeling is an important method of learning for children. Children observe the way others think, speak, and behave, and imitate those behaviors. Behavior can also be shaped with the reinforcement of specific behaviors through positive reinforcement (i.e. praise), that with repetition increases the exhibition of that behavior. Role play is another valuable learning method, as research has shown that we recall 80% of what we do but just 20% of what we read or hear (Wurdinger, S. D. (2005). Using experiential learning in the classroom: Practical ideas for all educators. Lanham, Md.: Scarecrow Education). The present invention utilizes these learning methods to introduce and reinforce the celebration of failure and reinforcement of effort. Several examples of group and solo activities have been described herein, but one of ordinary skill in the art will recognize that many different types of group and solo activities may be encouraged to reinforce aspects of method 100, and each of these is contemplated as being within the scope of the present invention.

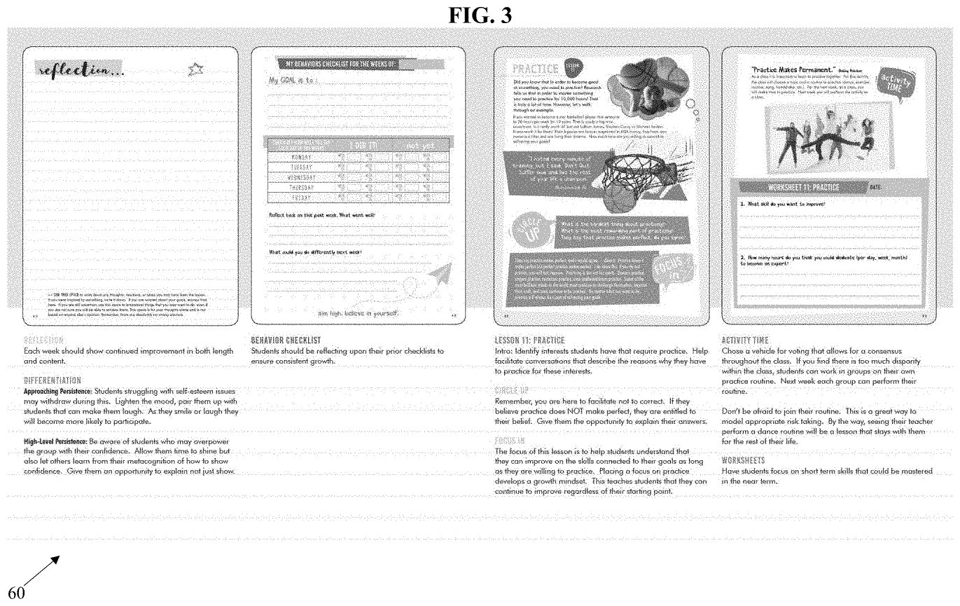

Finally and importantly, method 100 may include the step of training a teacher to perform the other steps of the method 52. While the basic method 100 need not necessarily be performed in a formal educational setting, it is likely more powerful when done so. As such, it is much preferred teachers be trained in method 100, as contemplated in step 52. Training the teacher 52 may entail providing the teacher with a workshop 54. In this case, the teacher herself is put in somewhat of a formal educational setting to learn the steps of method 100, the core tenets of the present invention, and how to effectively execute all. If the teacher is not available for a workshop, she may well execute the method 100 if the step of providing the teacher with a teaching manual 56 is performed. A teaching manual is a counterpart to a student manual or workbook. The teaching manual shows every page of the student workbook and includes notes and tips for the teacher beneath. FIG. 3 shows an example of a page 60 from a teaching manual. The step of providing the teacher with access to an online portal that provides at least information regarding the steps of the method and resources pertaining to the steps of the method 58 may also be executed. This step 58 of training the teacher is the most passive form of training the teacher 52, but it is a useful tool, regardless. This step 58 may comprise providing the teacher with recorded training videos. Importantly, step 58 may also be executed where the teacher is an adult, such as a parent, in the student's life other than her teacher in a formal setting. The teacher may be trained through a workshop 54 and a teaching manual 56, for example, while the student's parents may be trained through the portal 58. In this way, the core teaching from the teacher in the more formal educational setting may be reinforced at home. Parents are invited to participate in the present invention along with their children and the portal is an easy way to facilitate that participation. The portal is an online repository of information, articles, blogs, with many downloadable materials including exercises, activities, videos, and worksheets. Both parents and teachers are guided to follow the same process as the students: setting goals, measuring progress, celebrating success, etc.

To summarize, method 100 of the present invention develops and strengthens neural reinforcement pathways to promote sustained and maximal effort (over the long-term). This is achieved by rewarding failure associated with maximal effort. The curriculum is reinforced by the circle of influencers in the child's life (teacher, teacher's assistant, parents and/or caregivers, and peers (i.e. classmates). Research has shown that children will work hard for intrinsic rewards (vs. extrinsic). The reinforcement of failure with maximal effort will inevitably produce success as long as the individual does not give up. Method 100 is reinforced by a variety of mediums including but not limited to praise, storytelling, modeling, role play, writing and drawing.

Although the present invention has been described in considerable detail with reference to certain preferred versions thereof, other versions would be readily apparent to those of ordinary skill in the art. Therefore, the spirit and scope of the description should not be limited to the description of the preferred versions contained herein. Moreover, features disclosed herein but not claimed may be considered an aspect of the invention.

We claim:

1. A method for enhancing a student's likelihood of achieving success, said method comprising the steps of:
a) encouraging the student to set a goal;
b) encouraging the student to formulate milestones toward achieving the goal;
c) encouraging the student to attempt to progress through the milestones;
d) encouraging the student to record her progress through the milestones;
e) monitoring the student's progress through the milestones;
f) determining whether the student is using maximal effort to proceed through the milestones;
g) providing positive feedback to the student upon her success in proceeding through one or more milestones while using maximal effort;
h) providing positive feedback to the student upon her failure to proceed through one or more milestones while using maximal effort; and
i) emphasizing that struggle and failure are expected and necessary aspects of achieving the goal and that effort and persistence are the most important factors in achieving the goal.

2. The method as claimed in claim 1, wherein said step h) further comprises the step of encouraging the student to formulate a strategy to succeed in proceeding through the failed one or more milestones upon reattempt.

3. The method as claimed in claim 1, wherein said step h) further comprises the step j) of suggesting that the student edit the failed one or more milestones so as to make them more achievable upon reattempt.

4. The method as claimed in claim 3, wherein said step j) comprises suggesting that the student break the failed one or more milestones into smaller sub-milestones.

5. The method as claimed in claim 3, wherein said step j) comprises suggesting that the student edit the failed one or more milestones to make them more realistic for the student's circumstances.

6. The method as claimed in claim 1, wherein said step h) further comprises the step of encouraging the student to focus on improvement and discouraging the student from focusing on self-flagellation.

7. The method as claimed in claim 1, wherein said steps a) and b) further comprise the step of encouraging the student to add specificity to the goal and the milestones.

8. The method as claimed in claim 1, wherein said step a) further comprises the step of asking the student questions to help the student identify an area on which the student would like to improve or something the student would like to achieve.

9. The method as claimed in claim 1, wherein said step d) further comprises the step of encouraging the student to reflect on progress through the milestones regarding what actions are resulting in success and what actions might be done differently so as to better produce success.

10. The method as claimed in claim 1, wherein said step d) further comprises the step of encouraging the student to identify trends that correlate her behavior with progress or lack thereof through the milestones.

11. The method as claimed in claim 1, further comprising the step of k) encouraging the student to identify and take advantage of resources to aid the student through her progress through the milestones.

12. The method as claimed in claim 11, wherein said step k) further comprises the step of encouraging the student to ask people for help through her progress through the milestones.

13. The method as claimed in claim 1, further comprising the step of encouraging the student to celebrate her own success in proceeding through the milestones.

14. The method as claimed in claim 1, further comprising the step of encouraging the student to edit the milestones to make them more challenging upon succeeding in proceeding through one or more milestones with less than maximal effort.

15. The method as claimed in claim 1, further comprising the step of encouraging the student to engage with accountability partners to support her in her progress through the milestones.

16. The method as claimed in claim 1, further comprising the step of emphasizing said steps a) through d) and i) through group activities.

17. The method as claimed in claim 1, further comprising the step of emphasizing said steps a) through d) and i) through solo activities.

18. The method as claimed in claim 1, further comprising the step 1) of training a teacher to perform said steps a) through i).

19. The method as claimed in claim 18, wherein said step 1) comprises providing the teacher with a workshop.

20. The method as claimed in claim 18, wherein said step 1) comprises providing the teacher with a teaching manual.

21. The method as claimed in claim 18, wherein said step 1) comprises providing the teacher with access to an online portal that provides at least information regarding said steps a) through i) and resources pertaining to steps a) through i).

22. The method as claimed in claim 1, further comprising the step of encouraging the student to modify her environment to facilitate achieving the milestones.
